(19) United States
(12) Patent Application Publication
(10) Pub. No.: US 2004/0242034 A1
(43) Pub. Date: Dec. 2, 2004

(54) Electrical assembly and dielectric material

(75) Inventors: William M. Rinehart, Centralia, MO (US); Bradley W. Davis, Columbia, MO (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hubbell Incorporated

(21) Appl. No.: 10/448,462

(22) Filed: May 30, 2003

(51) Int. Cl. H01R 4/66

(52) U.S. Cl. 439/100

(57) ABSTRACT

An electrical assembly includes an electrical component contained within a housing and surrounded by a dielectric electrical insulating material. The dielectric material fills the space between the electrical component and the housing to eliminate air gaps or spaces and to surround the electrical component. The dielectric material is formed from a curable resin composition that includes a base resin, such as an epoxy resin, a flexibilizing agent, a curing agent and an amount of a resilient and compressible filler. The resilient and compressible filler is particles of thermoplastic microballoons having a particle size of about 90 microns to about 110 microns.

### FIELD OF THE INVENTION

The present invention is directed to an electrical assembly and to a dielectric material for use in an electrical assembly. The invention is further directed to an electrical assembly containing a flexible and resilient dielectric material to accommodate for changes in dimension between the electrical component and the housing of the electrical assembly. The invention is further directed to a method of producing the electrical assembly.

### BACKGROUND OF THE INVENTION

Electrical components are commonly placed into structures for support and protection from the environment. The electrical component may be surrounded with a dielectric material to support the electrical device as required by the electrical components and the supporting housing. The electrical insulating material surrounds the electrical component to prevent contact of the component with the housing, particularly where the housing is made of metal, and to protect the electrical component. The electrical insulating material provides a high dielectric strength media which eliminate the affects of arcing and electrical discharge from high voltage electrical components and between adjacent components.

One example of an electrical component is a vacuum interrupter or vacuum switch that is commonly used in many high voltage applications. The vacuum interrupters provide various interrupting and switching operations as known in the electrical industry. Vacuum interrupters are commonly used in circuit breakers and switches for power distribution. The vacuum interrupter commonly includes two large electrical contacts enclosed within a housing. The housing is often made of an evacuated ceramic material. Generally, one of the electrical contacts is stationary while the other contact moves between an open and closed position.

Vacuum interrupters are often supported within a housing that may also contain related circuit components. Examples of circuit components that are often included in a housing include current sensors, voltage sensors or other components to provide over-current protection. Other electrical components include measuring devices and monitoring relay devices to assist in the operation of the vacuum interrupter.

High voltage electrical components such as vacuum interrupters require suitable dielectric characteristics to provide electrical insulating properties surrounding the electrical component. The surrounding dielectric material is required to have the appropriate electrical insulating properties to prevent arcing between the various components of the assembly.

Electrical devices such as vacuum interrupters can be enclosed within a housing filled with an insulating oil or gas having a high dielectric strength to provide electrical insulation between the vacuum interrupter and adjacent components. The insulating oil or gas allows the various electrical components to be positioned close to one another thereby allowing the reduction of the volume of the assembly. The electrical assembly using insulating oils or gases require maintenance and specifically designed equipment to handle and recover the insulating material. In addition, the environmental hazards of insulating oils and gases has resulted in efforts to develop alternative insulating materials.

In recent years, polymeric materials have been developed for insulating electrical components. One example is disclosed in U.S. Pat. No. 5,585,611 to Harvey et al. This patent discloses a vacuum interrupter assembly having interrupter switch embedded within a body of a solid dielectric material. The solid dielectric material is disclosed as a polymer concrete such as an epoxy concrete. The polymer concrete is a composite material containing inorganic aggregates such as silica filler bonded together with a low viscosity organic resin.

Another example of a vacuum interrupter assembly is disclosed in U.S. Pat. No. 5,917,167 to Bestel. This patent discloses a vacuum interrupter assembly having a switching component enclosed within a vacuum assembly surrounded by a silicone material. The silicone material is in the form of a preformed sleeve that is expanded so that the vacuum assembly can be positioned within the sleeve. A housing is formed around the vacuum interrupter and the silicone sleeve to contain the vacuum assembly. The housing is disclosed as being made from an epoxy resin to encapsulate the vacuum interrupter and the silicone sleeve.

Other methods of insulating a vacuum interrupter include the formation of a polyurethane interface material between the support and the vacuum interrupter. The polyurethane or other resins can be produced as a foam. The vacuum interrupter is often made from a ceramic material. The outer shell is often made from an epoxy resin that surrounds the vacuum interrupter. The polyurethane dielectric material often experiences cracks and fractures during use and during manufacture. The differences in the expansion between the vacuum interrupter and the enclosure can result in cracks forming in the enclosure or the insulating material surrounding the vacuum interrupter. In addition the heat generated during curing of the polymer causes the electrical component and the housing to expand. As the assembly cools, the electrical component and the housing contract at different rates which can produce cracks in the electrical component, the housing or the cured dielectric material. The dielectric material can expand or contract during curing, which can also cause fractures in the assembly.

The electrical component assemblies and particularly the vacuum interrupter of the above noted patents have met with limited success. Accordingly, there is a continuing need in the industry for an improved electrical assembly and insulating material.

### SUMMARY OF THE INVENTION

The present invention is directed to an electrical assembly, a dielectric composition and to a method of producing the electrical assembly. The invention is particularly directed to an electrical assembly containing a dielectric material that is resistant to fractures and cracks during use and is able to maintain its structural integrity for extended periods of time and through temperature changes.

Accordingly, a primary aspect of the invention is to provide a dielectric material that is able to provide an insulating effect surrounding an electrical component and is resistant to mechanical failure during use. The dielectric material is able to accommodate for changes in dimension of an electrical component and a housing enclosing the electrical component due to the difference in the coefficient of linear expansion of the housing and the electrical component.

Another aspect of the invention is to provide a dielectric material that can be formed around an electrical component and adhered directly to the surface of the electrical components and to the housing. In one embodiment, the dielectric material includes an adhesion promoter or coupling agent to assist in bonding the dielectric material to the surfaces of the electrical component and housing.

Another aspect of the invention is to provide a dielectric material from a curable resin composition where the curable resin composition is sufficiently fluid to fill a space between an electrical component and a housing of an electrical assembly. The curable resin composition has a sufficiently low viscosity to flow readily between the electrical component and the housing to envelop the electrical component without formation of air pockets or gaps between the electrical component and the housing.

Still another aspect of the invention is to provide an electrical assembly having an electrical component and a housing surrounding the electrical component and a dielectric material surrounding the electrical component that fills the gap between the electrical component and the housing. The curable resin forms a dielectric material that is sufficiently flexible, compressible and elastic to absorb stress as a result of dimensional changes between the electrical component and the housing. The dimensional variations occur as a result of the different coefficients of linear thermal expansion between the housing and the electrical components. The dielectric material is sufficiently compressible to absorb the pressure caused by different rates of expansion of the electrical component and the housing without causing cracks or fractures in the electrical component, housing or dielectric material.

A further aspect of the invention is to provide a dielectric material formed from an epoxy resin and compressible filler. The compressible filler is included in an amount sufficient to provide the desired compressible properties while maintaining the structural integrity of the dielectric material.

Another aspect of the invention is to provide a curable resin composition for forming a dielectric material where the resin composition includes a flexible epoxy resin and an amount of thermoplastic microballoons as a filler. The thermoplastic microballoons are included in an amount to enable the epoxy resin to be compressible and resilient. The thermoplastic microballoons are able to be compressed and returned to the original shape and dimension after the compressing force is released. In one embodiment of the invention, the curable resin composition contains about 3 weight percent to about 10 weight percent based on the total weight of the composition.

Another aspect of the invention is to provide a curable resin composition for forming a dielectric material where the composition includes a flexible epoxy resin, a curing agent, a flexibilizing agent and thermoplastic microballoons as a filler. The composition can optionally contain an accelerator, an air release agent and a coupling agent to enhance the bonding to the dielectric materials to the surfaces of the electrical assembly.

The various aspects of the invention are basically obtained by providing an electrical assembly comprising an electrical component contained within a housing and an electrical insulating composition. The electrical component has an outer surface with at least one electrical connector. The housing is a substantially rigid structure surrounding the electrical component and has an outer wall spaced from the electrical component defining a cavity between the outer wall and the electrical component. The electrical insulating composition substantially fills the cavity between the electrical component and the housing and is adhered to the surfaces of the electrical component and the housing. The cavity is completely filled with the electrical insulating composition so that the cavity is free of trapped air. The electrical insulating material is compressible and flexible to withstand differences between the linear coefficient of thermal expansion of the electrical component and the linear coefficient of thermal expansion of the housing substantially without fracture or failure of the electrical insulating properties of the composition.

The aspects of the invention are further obtained by providing a method for producing an electrical assembly comprising the steps of positioning an electrical component within a housing, introducing a curable composition and curing the composition to form a dielectric material between the electrical component and the housing. The housing is substantially rigid and has a dimension to receive the electrical component and form a gap between the outer surface of the electrical component and the housing. The curable composition is introduced into the gap to fill the space between the electrical component and the housing. The curable composition comprises a curable base resin, curing agent, a flexibilizing agent and a resilient and compressible filler.

The aspects of the invention are further obtained by providing a resilient electrical insulating material, wherein the electrical insulating material is obtained from a composition comprising a resin, a flexibilizing agent, a curing agent and an amount of a resilient and a compressible particulate filler. In one embodiment, the resin is a curable epoxy resin and the resilient and compressible particulate filler are thermoplastic microballoons.

These and other aspects of the invention will become apparent from the following detailed description of the invention, which in conjunction with the annexed drawings, disclose one embodiment of the invention.

### BRIEF DESCRIPTION OF THE DRAWINGS

The following is a brief description of the drawings in which:

FIG. 1 is a partial cross-sectional side view of an electrical assembly showing the electrical component contained within a housing where the electrical component is surrounded by a dielectric material; and

FIG. 2 is a cross-sectional side view of the electrical assembly of FIG. 1 during assembly and manufacture.

### DETAILED DESCRIPTION OF THE INVENTION

The present invention is directed to an electrical assembly, a dielectric composition and to a method of producing the electrical assembly. The invention is particularly directed to an electrical assembly containing a dielectric material that is able to withstand the stress caused by different rates of expansion of the components of the electrical assembly.

The present invention relates to a novel dielectric material for use in an electrical assembly. The electrical assembly in the illustrated embodiment is a vacuum interrupter or vacuum bottle that is supported within the walls of a housing. The dielectric material forms a substantially continuous layer that surrounds the vacuum interrupter or other electrical component. It will be understood that other electrical devices can be used in the electrical assembly.

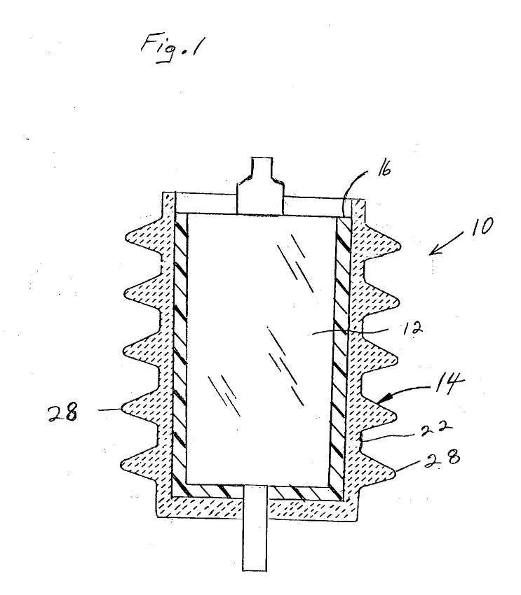

Referring to FIG. 1, the electrical assembly 10 includes an electrical component 12 supported within a housing 14. A dielectric material 16 forming an electrical insulating material fills the gap or space between electrical component 12 and housing 14 and surrounds the electrical component 12.

Electrical component 12 can be any suitable electrical device that can be fitted within a housing. The electrical component is usually a device that requires a housing for support and protection from weather. The electrical component typically requires an insulating layer surrounding the electrical component to protect the component and any adjacent components. In one preferred embodiment of the invention, electrical component 12 is a vacuum interrupter as known in the art. Electrical component 12 typically has at least two electrical connectors 18 and 20 carrying electrical current to electrical component 12.

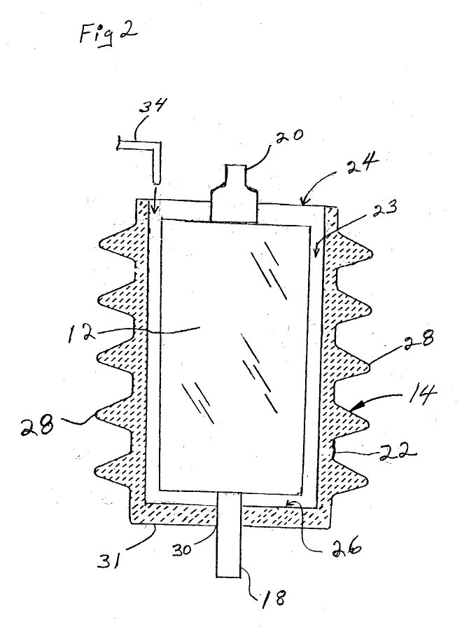

Housing 14 can have any suitable shape for supporting and enclosing electrical component 12. Referring to FIG. 2, housing 14 typically has a substantially cylindrical shape with a substantially cylindrical side wall 22 defining a cavity 23. In this embodiment housing 14 has an open top end 24 and a closed bottom end 26. Side wall 22 includes a plurality of radically disposed sheds 28. Housing 14 includes a first opening 30 located in bottom wall 31 to allow first electrical connector 18 to pass through and connect to a suitable electrical connection (not shown) a second opening can be provided on side wall 22 to allow second electrical connector 20 to pass through. In the embodiment illustrated, connector 20 extends through the open end 24 of housing 14. The location and orientation of electrical connectors 18 and 20 can be arranged depending on the type of electrical component 12 and the intended method of installation.

Housing 14 is typically a rigid molded one-piece unit where cavity 24 has a dimension to receive electrical component 12. Housing 14 is made of a suitable rigid material such as a polyester resin material as known in the art. Other suitable materials include ceramic materials, porcelain, cycloaliphatic epoxy resins and bisphenol A epoxy resins that are sufficiently rigid to provide the desired support and protection. The dimension of housing 14, particularly the thickness of the side wall 22, can vary depending on the intended use. In one embodiment of the invention, the side wall 22 of housing 14 has a thickness of about 0.1 inch to about 0.2 inch.

Electrical component 12, in the embodiment shown, is a vacuum interrupter as known in the art. Examples of vacuum interrupters are disclosed in U.S. Pat. No. 6,310,310 to Wristen, U.S. Pat. No. 5,917,167 to Bestel, U.S. Pat. No. 4,839,481, U.S. Pat. No. 4,871,888, U.S. Pat. No. 4,982,059 and U.S. Pat. No. 5,387,772 which are hereby incorporated by reference in their entirety. The vacuum interrupter typically has a ceramic or porcelain outer shell or casing. In alternative embodiments of the invention, other electrical components instead of or in addition to the vacuum interrupter can be included.

In one embodiment of the invention, housing 14 is a preformed unit. In the method of producing the assembly, electrical component 12 is fitted within the cavity of housing 12 to form a space between the outer surface of the electrical component 12 and the inner surface of housing 14. The space between electrical component 12 and housing 14 is generally about 0.25 inch or less. Typically, the space between electrical component 12 and housing is less than about 0.20 inch, and preferably about 0.10 inch to about 0.15 inch. In one preferred embodiment, the space between electrical component and housing is about 0.12 inch.

After electrical component 12 is fitted within the cavity of housing 14 and is fixed in place, a dielectric, electrical insulating material 16 is introduced to fill the space or interface between electrical component 12 and housing 14 and remove the air. In preferred embodiments of the invention, substantially no air gap or space is present between electrical component 12 and housing 14 to provide a reliable high dielectric strength. In preferred embodiments, a liquid curable resin is introduced into the cavity of housing 14 and then cured to form the dielectric material in place.

Electrical insulating material 16 is a flexible, resilient and compressible material having a high dielectric strength that is able to withstand the high voltages commonly associated with a vacuum interrupter and other high voltage electrical components. The electrical components 12 and housing 14 can be made of the same or similar materials but are often made of different materials. The different materials inherently have a different linear coefficient of thermal expansion. The differences in the linear coefficient of thermal expansion result in relative movement between electrical component 12 and housing 14, which can cause the formation of fractures or cracks in the dielectric, electrical insulating material. Where the dielectric material is rigid or not flexible, the changes in the dimensions of the electrical component 12 and the housing 14 as a result of temperature changes can also produce cracks or fractures in the housing which can allow moisture to migrate into the housing which can cause corona. These fractures in housing 14 can also lead to insulation failure. The fractures in housing 14 can lead to failure of the electrical insulation, electrical component 12 and eventual failure of the assembly 10.

In preferred embodiments of the invention, the electrical insulating material is sufficiently compressible and resilient to accommodate for differences in the linear coefficient of thermal expansion without causing fracture or failure of the housing, electrical component or the dielectric electrical insulating material. The electrical insulating material is compressible so that changes in the dimensions of the housing and/or the electrical component are absorbed by the electrical insulating material. The electrical insulating material is also sufficiently resilient so that the housing and the electrical component can return to the original dimension during changes in temperature without causing fractures in the housing or electrical component and without separation from the housing wall or the electrical component.

The flexible, resilient and compressible electrical insulating material is preferably bonded to the opposing surfaces of the electrical component and the housing. In this manner, changes in the dimension of the space between the electrical component and the housing are accommodated by the electrical insulating material without separation or failure. The electrical insulating material is sufficiently compressible to be able to compress as the space between the opposing walls decreases due to changes in temperature. In a similar manner, the resilience and elasticity of the electrical insulating material and the bonding to the electrical component and the housing wall enable the electrical insulating material to expand and stretch as the space between the opposing walls increases without separation from the opposing walls and without the formation of cracks, fractures or air gaps in the electrical insulating material or between the electrical insulation material and the electrical component and the wall of the housing. The electrical insulating material is flexible and resilient with sufficient memory to return to its original shape and dimensions as compressive stress is released through changes in temperature.

In one embodiment of the invention, the electrical assembly is assembled from preformed units. In these embodiments, an electrical component is positioned within the housing unit to form a space between the electrical component and the housing. The electrical insulating material is formed from a curable liquid or fluid monomer or prepolymer composition that can be poured or injected into the space to fill the gap completely. Preferably the monomer or prepolymer liquid composition has a sufficiently low viscosity to flow easily into the gap and to expel substantially all of the air in the gap. When necessary, standard processing techniques can be used to ensure all or substantially all of the air is removed from the gap. The monomer or prepolymer composition is preferably curable at room temperature but can be heat curable depending on the composition used. The composition is preferably cured without significant expansion or build-up of internal pressures to prevent fracturing of the housing or the electrical component. In the event internal pressures are developed during curing, the compressible nature of the resulting electrical insulating material absorbs the internal pressure to relieve the pressure against the electrical component and the housing wall.

In preferred embodiments of the invention, electrical component 12 is positioned in housing 14 and the space between electrical component 12 and housing 14 is filled with the dielectric material. In an alternative embodiment, the electrical insulating material can be molded or coated directly onto the electrical component prior to assembly. The housing can then be molded around the coated electrical component by placing it in a mold cavity and introducing a suitable material into the mold cavity around the coated electrical component. In preferred embodiments, the electrical insulating material and the material for forming the housing are compatible so that the electrical insulating material forms a tight bond with the housing. In addition, the electrical insulating material is sufficiently resilient and compressible to inhibit or prevent fracturing of the housing during the molding step. During the molding of the housing from various polymeric resins, the heat applied to cure the resin and the heat generated during the curing can result in different expansion and contraction rates between the housing and the electrical component. The polymeric material used to form the housing can shrink as the polymer cures and cools. The shrinkage can cause the housing to fracture or cracks during curing when the electrical insulating material is too rigid. In preferred embodiments, the electrical insulating material is sufficiently compressible to compensate for the shrinkage of the housing without causing fracturing of the housing and without transferring the compression to the electrical component.

The electrical insulating material fills the space between the housing and the electrical component and bonds securely to the opposing surfaces to eliminate any air gap between the opposing surfaces. The elimination of an air gap and the formation of a continuous insulating layer is important to provide the high dielectric strength necessary for the electrical component, and particularly for a vacuum interrupter. The electrical insulating material has a thickness of about 0.10 inch to about 0.30 inch and typically about 0.10 to about 0.17 inch. In preferred embodiments, the electrical insulating material has a thickness of about 0.13 inch to about 0.15 inch. In one embodiment the electrical insulating material has a thickness of about 0.14 inch.

The electrical insulating material has a thickness and composition to provide sufficient dielectric strength for the electrical component and the intended use. The electrical insulating material has a dielectric strength to be substantially free of corona at the required voltages for the electrical component and the assembly. The dielectric strength can vary depending on the intend use. In one embodiment the electrical insulating material has a dielectric strength to be substantially free of corona at a voltage of at least about 14 kilovolts, preferably at least about 16 kilovolts, and more preferably at least about 17 kilovolts. In another embodiment, the electrical insulating material was found to be substantially free of corona of up to 27 kilovolts.

Housing 14 can be made from various materials that are able to provide the desired structural integrity and protection to the electrical component. In a preferred embodiment, housing 14 is made from a glass fiber reinforced rigid polymer resin. In one preferred embodiment, housing 14 is made from a rigid polyester resin that is reinforced with glass fibers. Preferably, housing 14 is made from a rigid material that is able to provide necessary strength to support and protect the electrical component. Typically, the polymeric resin materials used to produce the housing include a glass fiber reinforcing material.

Electrical insulating material is preferably produced from a curable liquid composition that has a sufficiently low viscosity to be pourable and is able to flow into the void or gap between the housing and the electrical component. Preferably, the curable composition has a viscosity to flow by gravity between the electrical component and the housing to displace all of the air in the housing.

In the embodiment shown in FIG. 1, housing 14 has an open end to receive electrical component 12. Side wall 22 of housing 14 has an axial length that is greater than the axial dimension of electrical component 12, whereby electrical component 12 is recessed within housing 14. The curable composition is poured or injected into the open end of housing 14, such as through a dispensing nozzle 34 to fill the cavity 23 of housing 14 and surround electrical component 12 and fill the gap or space between electrical component 12 and housing 14 to remove substantially all of the air. In other embodiments, housing 14 can include closure or cover that is coupled to the side walls to close the open end of housing 14. A suitable opening or port can also be provided in housing 14 to introduce the curable composition into the housing to fill the gap and surround the electrical component.

The dielectric electrical insulating material is produced from a pourable curable composition comprising a curable resin and a resilient and compressible particulate filler. A curing agent or crosslinking agent is generally added in amounts to provide an effective curing rate and to ensure complete curing of the resin to a stable electrical insulating material. Preferably, the curable composition has a working time of at least about 5 minutes. The composition is cured to a solidified form to provide the desired resilient and compressible properties.

The curable resin can be any suitable resin that when cured is sufficiently flexible and resilient to be able to form a resilient dielectric insulating layer. In a preferred embodiment, the resin is an epoxy resin that is able to cure at room temperature in the presence of a curing agent. A particularly suitable epoxy resin is available under the tradename EPON 828 from Resolution Performance Products. Preferred epoxy resins are Bisphenol A epoxy resins. In one embodiment, the epoxy resin is diglycidyl ether of Bisphenol A. EPON 838 from Resolution Performance Products is an example of a diglycidyl ether of Bisphenol A.

In further embodiments, other flexible polymeric resins can be used to form the dielectric material, although the epoxy resins are generally preferred. Examples of other curable resins include, for example, cyanate esters, silanes, polyamides, bismaleimide triazines and urethanes. The base resin for forming the dielectric material can vary depending on the particular materials for the electrical component and the housing. The requirements for the flexibility, resilience and ability to bond to the surfaces of the electrical components and the housing are essentially the same. In preferred embodiments, the curable resin composition is able to form a compressible, resilient and elastic dielectric material that is substantially free of corona discharge at about 17 kilovolts.

A curing agent is included with the base resin in an amount sufficient to effectively cure the resin while providing sufficient working time to be able to be poured into the cavity before becoming too viscous. In one embodiment of the invention, the curing agent is included in amounts of about 10 wt % to about 20 wt %, and preferably about 16 wt % to about 18 wt % based on the total weight of the composition. Suitable curing agents include amines, imides and carboxylic acid anhydrides as known in the art. The amounts of the curing agent added will depend on the desired rate of cure and the equivalent weights of the resin and curing agents used. One example of a suitable curing agent is sold under the tradename D-400 by Huntsman, which is a polyoxypropylenediamine.

The curable resin composition comprises about 25 wt % to about 60 wt % of the base resin such as the epoxy resin. In preferred embodiments, the resin composition comprises about 30 wt % to about 35 wt % and more preferably about 31 wt % to about 33 wt % of the base resin based on the total weight of the curable composition.

An optional accelerating agent can be included in the curable resin composition as needed to provide a desired rate of cure. Typically, the accelerating agent is included in amounts of about 1 wt % to about 10 wt % and preferably about 1 wt % to about 3 wt % based on the total weight of the resin composition. One example of a suitable accelerating agent for the epoxy resin is sold under the tradename ACCELERATOR 399 by Huntsman, which is an amine.

Preferably, the curable resin composition comprises a flexibilizing agent in an amount to provide sufficient flexibility and resilience to the cured resin. One suitable flexibilizing agent is nonylphenol which is particularly suitable for use in combination with the epoxy resin. Other flexibilizing agents can be included as known in the art, such as polyfunctional polyols. The flexibilizing agent is preferably included in amounts of about 10 wt % to about 60 wt % based on the total weight of the curable resin composition. Preferably, the flexibilizing agent is included in amounts of about 45 wt % to about 55 wt % based on the total weight of the composition. Other suitable flexibilizing agents are plasticizers such as butylbenzyl phthalate and flexible resins such as EPIREZ 505, which is epoxidized castor oil. As used herein, the term “flexibilizing agent” refers to a compound that is included with the curable composition to increase the flexibility of the cured resin.

The flexibilizing agent is selected and combined with the base polymer in an amount to provide the desired resilience and flexibility of the cured composition. Preferably, the flexibilizing agent is included in an amount to provide sufficient elastic properties to the cured resin, whereby the resulting dielectric material can stretch without the formation of cracks or fractures. The flexibilizing agent is also included to provide sufficient flexibility to compensate for changes in the dimension of the electrical component and the housing during assembly, curing of the various resins, and during use.

An optional air release agent can be included in amounts of about 0.1 wt % to about 2 wt %. The air release agent can be included as necessary in an amount to allow air bubbles to escape from the liquid resin composition and to prevent foaming during mixing and curing. A suitable air release agent is BMC-806 sold by Bergen Materials Corp.

In a preferred embodiment, the composition includes an adhesion promoter, a bonding agent, or coupling agent to assist in the adhesion of the resulting cured dielectric composition to the surfaces of the electrical component and the housing. In a preferred embodiment, the bonding agent is a silane coupling agent. Many commercially available silane coupling agents are known by one skilled in the art for use in improving the coupling or bonding to the surface of an article. Silane coupling agents are particularly suitable for improving the adhesion of polymeric resins to glass, ceramic and porcelain surfaces of the electrical component. The silane coupling agent is included in an amount of about 0.5 wt % to about 2 wt % based on the total weight of the composition.

Various adhesion promoters are known in the art and are commercially available. One example of a suitable adhesion promoter is aminoethylaminopropyltrimethoxysilane sold as a silane coupling agent under the Tradename Z-6020 SILANE by Dow Corning Company. Other commercially available silane coupling agents are available from Dow Corning Company under the tradename Z-6040 SILANE, which is 3-glycidoxy-propyltrimethyoxysilane.

The curable resin composition includes a compressible filler in an amount sufficient to provide the desired compressibility and resilience to the cured dielectric material. Preferably, the filler is an amount of thermoplastic microballoons. The thermoplastic microballoons preferably have a flexible shell that enable compression of the microballoons by an external force without rupturing. The shell of the thermoplastic microballoons is flexible and resilient to compress under pressure and to return to its original shape and dimensions when the compression force is released. Preferably, the thermoplastic microballoons have a substantially spherical shell encapsulating a gas.

The thermoplastic microballoons preferably have a particle size that is sufficiently large to provide the compression-absorbing effect for the resin composition. Microballoons preferably have a particle size of at least about 5 microns. The particle size of the microballoons is also sufficiently small to enable an effective amount of the microballoons to be suspended in the curable resin composition and to enable the composition to be pourable for filling the gap between the electrical component and the housing. In one embodiment of the invention, the thermoplastic microballoons have particle size of about 90-110 microns.

The amount of microballoons added to the curable resin composition can vary depending on the base resin, the desired compressibility, the desired viscosity of the composition before curing and the ability to suspend the microballoons in the curable resin composition. In one embodiment, the curable resin composition contains about 0.5 wt % to about 10 wt % microballoons, and preferably about 1 wt % to about 3 wt % based on the total weight of the curable resin composition.

Thermoplastic microballoons that are suitable for use in the invention are commercially available from various sources. In one embodiment, the microballoons have an acrylonitrile copolymer shell, although other thermoplastic polymers can be used as known in the art. Commercially available microballoons often have a coating of a suitable anti-caking agent, such as calcium carbonate, to inhibit agglomeration of the microballoons and assist in dispensing the microballoons in the resin composition. One example of suitable microballoons are available under the tradename Duralite M6050 AE from Pierce & Stevens Corp.

The curable resin composition of the invention in one embodiment comprises about 25 wt % to about 40 wt % of an epoxy resin, about 10 wt % to about 20 wt % of a curing agent, about 10 wt % to about 60 wt % of a flexibilizing agent, and about 0.5 wt % to about 10 wt % of thermoplastic microballoons. In another embodiment, the composition can contain about 0.5 wt % to about 2 wt % of a silane coupling agent. The composition can optionally contain about 1 wt % to about 10 wt % of an accelerator and about 0.1 wt % to about 2 wt % of an air release agent. In another preferred embodiment, the curable composition comprises about 25 wt % to about 35 wt % of an epoxy resin, about 16 wt % to about 18 wt % of a curing agent, about 1 wt % to about 3 wt % of an accelerator about 45 wt % to about 55 wt % of a flexibilizing agent, about 0.1 wt % to about 2 wt % of an air release agent, about 0.5 wt % to about 2 wt % of a silane coupling agent, and about 1 wt % to about 3 wt % of microballoons.

### EXAMPLE 1

A curable liquid resin composition was prepared from 100 parts of EPON 828 epoxy resin from Resolution Performance Products, 43.5 parts D-400 curing agent, 6.5 parts of ACCELERATOR 399, 150 parts nonylphenol as a flexibilizing agent, 0.5 parts BMC-806 as an air release agent, and 5 parts Duralite M6050 AE thermoplastic microballoons from HM Royal where the parts are by weight. The composition was mixed to suspend the microballoons in the curable liquid resin composition. The resulting curable composition was a pourable liquid and had a sufficient working time of at least about 5 minutes.

A glass container was placed in an outer container made from a rigid epoxy resin containing aluminum trihydrate as a filler. The outer container had a thickness of about 0.12 inch. The gap between the glass and the outer container also had a radical dimension of about 0.12 inch. The curable resin compositions was poured into the gap between the glass container and the outer container. The resin composition had a sufficiently low viscosity to pour easily and flow into the gap to completely fill the gap and displace the air without trapping air bubbles. The resin was allowed to cure to form a flexible and compressible layer that was free of trapped air. After curing, the inner and outer containers and the cured layer exhibited no cracks, fractures, shrinkage or separation of layers.

### EXAMPLE 2

A curable resin composition was prepared as follows.

DIELECTRIC MATERIAL FORMULATION

| DESCRIPTION | MATERIAL | PHR | % WEIGHT |
|---|---|---|---|
| BPA EPOXY | EPON 828 | 100.0 | 32.41 |
| CURING AGENT | D-400 | 43.49 | 14.10 |
| ACCELERATOR | ACCELERATOR 399 | 6.51 | 2.11 |
| FLEXIBILIZER | NONYL PHENOL | 150.0 | 48.62 |
| AIR RELEASE AGENT | BMC-806 | 0.5 | 0.16 |
| COUPLING AGENT | DC Z-6040 | 3.0 | 0.97 |
| MICROBALLOONS | DUALITE M6050AE | 5.0 | 1.62 |
| | Total → | 308.5 | 99.99 |

In the Table, PHR refers to the parts by weight based on 100 parts by weight of the resin. The resulting composition was pourable and cured to a flexible and resilient dielectric material.

While various embodiments have been chosen to illustrate the invention it will be understood by those skilled in the art that various changes and modifications can be made without departing from the scope of the invention as defined in the appended claims.

What is claimed:

1. An electrical assembly comprising:
an electrical component having an outer surface and having at least one electrical connector;
a substantially rigid housing encircling said electrical component and having an outer wall spaced from said electrical component and defining a cavity between said outer wall and said electrical component; and
a electrical insulating material substantially filling said cavity and adhered to said electrical component and to said outer wall of said housing where said cavity is substantially free of trapped air, and wherein said electrical insulating material is compressible and sufficiently flexible to withstand stress caused by differences between a linear coefficient of thermal expansion of said electrical component and a linear coefficient of thermal expansion of said housing substantially without fractures or failure of electrical insulating properties of said material.

2. The electrical assembly of claim 1, wherein said electrical component is a vacuum interrupter.

3. The electrical assembly of claim 1, wherein said electrical component has a first linear coefficient of thermal expansion and said housing has a second linear coefficient of thermal expansion that is different than said first linear coefficient of thermal expansion.

4. The electrical assembly of claim 3, wherein said electrical component has an outer surface made of a ceramic material and wherein said outer wall of said housing has an inner surface made of a polymeric resin and wherein said electrical insulating composition is adhered to said outer surface of said electrical component and said inner surface of said housing.

5. The electrical assembly of claim 4 wherein said polymeric resin is selected from the group consisting of epoxy resins and polyester resins.

6. The electrical assembly of claim 4, wherein said housing is made from a glass fiber reinforced polyester resin.

7. The electrical assembly of claim 1, wherein said electrical insulating material is produced from a curable composition comprising a resin, a curing agent and particulate compressible filler.

8. The electrical assembly of claim 7, wherein said particulate filler is thermoplastic microballoons.

9. The electrical assembly of claim 8, wherein said electrical curable composition comprises about 0.5 wt % to about 10 wt % of said thermoplastic microballoons.

10. The electrical assembly of claim 8, wherein said electrical curable composition further comprises a flexibilizing agent.

11. The electrical assembly of claim 8, wherein said thermoplastic microballoons are resilient and have sufficient memory to return to a substantially original shape and dimension after compression.

12. The electrical assembly of claim 8, wherein said electrical curable composition comprises about 0.5 wt % to about 10 wt % of said thermoplastic microballoons and wherein said microballoons comprise an acrylonitrile copolymer shell.

13. The electrical assembly of claim 8, wherein said thermoplastic microballoons have a particle size of about 90 microns to about 110 microns.

14. The electrical assembly of claim 8, wherein said curable composition comprises a silane coupling agent in an amount to bond said composition to surfaces of said electrical component and said housing.

15. The electrical assembly of claim 8, wherein said curable composition further comprises an air release agent.

16. The electrical assembly of claim 1, wherein said cavity has a width of about 0.1 to about 0.2 inch between said electrical component and said housing.

17. The electrical assembly of claim 7, wherein said resin of said electrical insulating material is an epoxy resin and wherein said composition further comprises a flexibilizing agent in an amount whereby said composition is resilient and flexible.

18. The electrical assembly of claim 7, wherein said electrical insulating composition is substantially clean of corona discharge at 17 kilovolts.

19. A method of producing an electrical assembly, said method comprising the steps of:
positioning a substantially rigid electrical component in a substantially rigid housing, said electrical component and said housing having a respective dimension to form a gap therebetween;
introducing a curable composition into said gap to fill a space between said electrical component and said housing, said composition comprising a curable base resin, a curing agent, a flexibilizing agent and a resilient and compressible filler; and
curing said composition to form a dielectric material between said electrical component and said housing.

20. The method of claim 19, wherein said electrical component is a vacuum interrupter having a body portion, and wherein said body portion is spaced from said housing by said dielectric material.

21. The method of claim 19, comprising completely filling said gap between said electrical component and said housing with said composition whereby said gap is devoid of air bubbles or air spaces.

22. The method of claim 19, comprising injecting said composition into said gap.

23. The method of claim 19, wherein said composition is a pourable liquid and said method comprises pouring said composition into said gap and allowing said composition to flow between said electrical component and said housing.

24. The method of claim 19, wherein said gap defines a space between said electrical component and said housing of about 0.1 to about 0.2 inch.

25. The method of claim 19, wherein said curable base resin is an epoxy resin.

26. The method of claim 19, wherein said filler is an amount of thermoplastic microballoons having a particle size of about 90-110 microns.

27. The method of claim 26, wherein said curable composition comprises about 0.5 wt % to about 10 wt % of said thermoplastic microballoons and wherein said microballoons comprise an acrylonitrile copolymer shell.

28. The method of claim 26, wherein said curable composition contains an amount of said thermoplastic microballoons whereby said resulting dielectric material is sufficiently flexible and compressible to absorb stress caused by differences between a linear coefficient of thermal expansion of said electrical component and a linear coefficient of thermal expansion of said housing.

29. The method of claim 19, wherein said dielectric material is substantially clean of corona discharge at 17 kilovolts.

30. The method of claim 19, wherein said dielectric material is substantially clear of corona at 27 kilovolts.

31. The methods of claim 19, wherein said composition further comprises a silane coupling agent and where said dielectric material is bonded to said electrical component and to said housing.

32. The method of claim 31, wherein said composition comprises about 0.5-2.0 wt % of said silane coupling agent.

33. The method of claim 19, wherein said composition further comprises an air release agent.

34. A resilient electrical insulating material, wherein said insulating material is obtained from a composition comprising:
a curable resin;
a flexibilizing agent;
a curing agent; and
an amount of a resilient and compressible particulate filler.

35. The electrical insulating material of claim 34, wherein said resin is a liquid curable epoxy resin and wherein said electrical insulating material is compressible.

36. The electrical insulating material of claim 34, wherein said composition further comprises an air release agent.

37. The electrical insulating material of claim 34, wherein said composition further comprises a silane coupling agent.

38. The electrical insulating material of claim 34, wherein said compressible filler is an amount of thermoplastic microballoons.

39. The electrical insulating material of claim 38, wherein said microballoons have a diameter of about 90-110 microns.

40. The electrical insulating material of claim 34, wherein said flexibilizing agent is nonylphenol.

41. The electrical insulating material of claim 34, wherein said composition is a mixture of
about 25 wt % to about 40 wt % of said curable resin;
about 10 wt % to about 20 wt % of said curing agent;
about 10 wt % to about 60 wt % of said flexibilizing agent; and
about 0.5 wt % to about 10 wt % of said compressible filler and wherein said compressible filler is an amount of thermoplastic microballoons; and
curing said resin, and where said electrical insulating material is flexible and compressible.

42. The electrical insulating material of claim 41, wherein said resin is a flexible epoxy resin.
